(19) United States
(12) Patent Application Publication
(10) Pub. No.: US 2020/0313215 A1
(43) Pub. Date: Oct. 1, 2020

(54) MEMBRANES FOR FUELS CELLS AND METHOD OF MAKING SAME

(71) Applicant: POCELL TECH LTD., Caesarea (IL)

(72) Inventors: Miles PAGE, Hod Hasharon (IL); Yair PASKA, Kiryat Ata (IL); Alina AMEL, Binyamina (IL)

(73) Assignee: POCELL TECH LTD., Caesarea (IL)

(21) Appl. No.: 16/765,539

(22) PCT Filed: Nov. 20, 2018
(86) PCT No.: PCT/IL2018/051257

§ 371 Date: May 20, 2020

(30) Foreign Application Priority Data
Nov. 20, 2017 (IL) 255766

(51) Int. Cl. H01M 8/1039; H01M 8/1004; H01M 8/1088; C08J 5/22; C25B 9/10; C25B 13/08

(52) U.S. Cl. CPC H01M 8/1039; H01M 8/1004; H01M 8/1088; C08J 5/2262; H01M 2008/1095; C25B 9/10; C25B 13/08; C08J 2365/02; C08J 5/2293

(57) ABSTRACT

A membrane for fuel cells, such as PEM and/or AEM fuel cells and/or electrolyzers is disclosed. Such a membrane (e.g., an anion conducting membrane) may include: crosslinked ionomer comprising two types of functional groups: a first type of functional groups forming crosslinking bonds between two ionomer chains; and a second type of functional groups comprising ion conducting functional groups. In some embodiments, the crosslinking bonds may not include the ion conducting functional groups. A catalyst coated membrane (CCM) is also disclosed. In such case the membrane may further include at least one catalyst layer attached to at least one side of the membrane to form the catalyst coated membrane (CCM). The at least one catalyst layer may include catalyst nanoparticles and crosslinked ionomer of the catalyst layer comprising two types of functional groups.

### TECHNICAL FIELD OF THE INVENTION

The invention generally relates to membranes for fuel cells and electrolyzers and methods of making such membrane. More specifically the invention relates to membranes for fuel cells and electrolyzers having two types of different functional groups.

### BACKGROUND OF THE INVENTION

As the use of solid membrane fuel cells expands, there is a constant need to improve the stability and efficiency of the fuel cells. Both alkaline exchange membrane (AEM) fuel cells and proton exchange membrane (PEM) fuel cells have similar basic structure that includes a polymeric conducting membrane, and an anode and a cathode catalyst layer, one layer on each side of the membrane. The AEM and PEM fuel cells differ at least in the electrochemical reactions and the ion conducting groups in the polymeric conducting membrane, in the anode catalyst layer, and in the cathode catalyst layer.

Increasing stability and mechanical durability of the polymeric conducting membrane and the catalyst layers may include crosslinking the polymeric chains in the membrane and/or the catalyst layers and optionally also in the interface between the membrane and the catalyst layers. Crosslinking may prevent excessive swelling of the membrane in water, as well as leaching out of polymer chains into the fuel cell product water and mechanical creep of the membrane under compression stress in the fuel cell.

Commonly, functionalization of the polymer (e.g., in a precursor form) to form ionomer (i.e., polymer having ion-conducting functional groups) is conducted prior to or during the crosslinking. Accordingly, ionomers are used to form the membrane and/or the catalyst layers are being crosslinked via at least some of the ion-conducting functional groups. For example, in AEM fuel cells, a polymerization reaction may be carried out to yield a non-ion-conducting precursor material with an alkyl halide (for example, Br, Cl or I) functional group (i.e. precursor polymer), that can later be functionalized to a positively charged quaternary ammonium anion conducting group via amination reaction (1):

—R—X+N(CH₃)₃→—R—N⁺—(CH₃)₃+X⁻ (1)

Where R stands for the alkyl- or aryl-based tether functionalization of the polymer monomers, X stands for the halide and N⁺ stands for the ion conducting group. An example for such a reaction is given in FIG. 1A, which demonstrates an amination reaction of a styrene based polymer precursor to form a positively charged quaternary ammonium anion conducting group.

Following the functionalization of the polymer precursor the ionomer in the membrane and/or catalyst layers can be crosslinked. For example, following reaction (1) an amination reaction may be performed on the ionomer precursor. The amination reaction forms quaternary ammonium ion conducting group at each of its alkyl halide groups with different halogen groups at two different monomers, yielding a cross-linkage between two chains of the formed cast membrane via amination reaction (2):

2[—R—X]+(CH₃)₂N—R′—N(CH₃)₂→—R—N⁺(CH₃)₂—R′—(CH₃)₂N⁺—R—+2X⁻ (2)

Where R′ stand for the carbon chain of the diamine. An example for such a reaction is given in FIG. 1B which demonstrates a crosslinking reaction of a styrene based precursor polymer (of FIG. 1A) to form a linkage between two polymer chains using tetramethyl-1,6-hexanediamine (TMHDA) crosslinking agent.

Crosslinking ionomers may yield an anion conducting membrane with crosslinked ionomer chains that is mechanically robust and yet highly conductive. However ion-conductive ionomers are still sensitive to decomposing either by exposure to OH⁻ or H⁺ ions (the conducting-ion in AEM or PEM fuel cells), by free radicals generated in electrochemical reactions at the electrodes in a FC or electrolyzer, by attack of the polymer by its associated OH⁻ or H⁺ ions, as well as other possible mechanisms. Such a degradation pathway leads to loss of ion conductivity, loss of mechanical strength and loss of water affinity of the membrane or ionomer.

Accordingly, a new method for crosslinking of membranes and catalyst layers in fuel cells is disclosed. The method may yield a new chemical structure of membranes and/or catalyst layers that may have better stability and degradation durability than fuel cells known in the art.

### SUMMARY OF THE INVENTION

Some aspects of the invention may be directed to a membrane for fuel cells, such as PEM and/or AEM fuel cells and/or electrolyzes. Such a membrane (e.g., an anion conducting membrane) may include: crosslinked ionomer comprising two types of functional groups: a first type of functional groups forming crosslinking bonds between two ionomer chains; and a second type of functional groups comprising ion conducting functional groups. In some embodiments, the crosslinking bonds may not include the ion conducting functional groups. In some embodiments, the membrane may further include a mesh for supporting the crosslinked ionomer.

In some embodiments, the first type of functional group contains one of: a dithioether type crosslink of the form P—R—S—R′—S—R—P, and an alkyl or aryl crosslink of the form P—R—P, where P represents the ionomer chains being crosslinked, R and R′ being alkyl or aryl chain, and S being a sulfur atom. In some embodiments, the second type of functional groups may an anion conducting type of functional groups, In some embodiments, the second type of functional group may be a quarternary ammonium type of functional group.

Some embodiments of the invention may be directed to a catalyst coated membrane (CCM). In such case the membrane may further include at least one catalyst layer attached to at least one side of the membrane to form a catalyst coated membrane (CCM). The at least one catalyst layer may include catalyst nanoparticles and crosslinked ionomer of the catalyst layer comprising two types of functional groups: a third type of functional groups comprising hydrocarbon chain forming cross-linking bonds between two ionomer chains of the catalyst layer; and a forth type of functional groups comprising ion conducting functional groups. In some embodiments, the crosslinking bonds may not include the ion conducting functional groups.

In some embodiments, a first catalyst layer attached to a first side of the CCM may include first catalyst nanoparticles and the crosslinked ionomer of the catalyst layer and a second catalyst layer attached to a second side of the CCM may include non-crosslinked ionomer of the catalyst layer and second catalyst nanoparticles. In some embodiments, the first and third types of functional groups are the same and the same cross-linked chemical bonds across the interface between the membrane and the at least one catalyst layer.

Some aspects of the invention may be directed to a fuel cell that may include a membrane according to any embodiments of the invention or an electrolyzer that may include a membrane according to any embodiments of the invention.

Some embodiments of the invention may be directed to a method of making a membrane for fuel cells. The method may include: providing polymer precursor solution comprising monomers having a first type of functional groups and monomers having a second type of functional groups wherein the first and second types of functional groups are different from each other; adding crosslinking agent to the solution, the cross-linking agent being configured to chemically bond to the functional groups of the first type; cross-linking the polymer precursor, and adding ion conduction functionalization agent, the ion conduction functionalization agent being configured to chemically react with the functional groups of the second type to form ion conducting functional groups.

In some embodiments, the cross-linking agent may include one of a group consisting of: hydrocarbon chains, sulfur groups, siloxy groups, N-hydroxybenzotriazole groups and Azide groups. In some embodiments, the cross-linking agent may include one of a group consisting of: dithiol and dihalide and divinyl. In some embodiments, the method may further include casting the polymer precursor solution and the crosslinking agent to form a membrane. In some embodiments, the method may further include evaporating a solvent from the solution to form a drier membrane. In some embodiments, casting the polymer precursor solution may include inserting the solution into a mesh.

In some embodiments, the method may further include providing at least one catalyst solution comprising, at least one type of catalyst nanoparticles and a polymer precursor of a catalyst layer, wherein monomers in the polymer precursor have a third and a forth types of functional groups different from each other; adding crosslinking agent to the at least one catalyst solution, the cross-linking agent being configured to chemically bond to the functional groups of the third type; applying at least one layer of the at least one catalyst solution on at least one side of the membrane to form a catalyst coated membrane; cross-linking the polymer precursor in the at least one layer; and adding ion conducting functionalization agent, the ion conducting functionalization agent being configured to chemically react with the functional groups of the forth types to form ion conducting functional groups. In some embodiments, applying the at least one catalyst solution is on a first side of the as cast membrane, and the method may further include applying another catalyst solution on a second side of the as cast membrane, the second catalyst solution may not include the crosslinking agent.

In some embodiments, crosslinking the polymer precursor in the membrane and the crosslinking the polymer precursor in the at least one layer may be conducted in separate steps. In some embodiments, the first type of functional group may be the same as the third type functional group. In some embodiments, cross-linking the polymer precursor in the membrane and cross-linking the polymer precursor in the at least one layer are conducted simultaneously. In some embodiments, the second type functional groups is the same as the forth type functional groups.

In some embodiments, the method may further include: providing a first catalyst solution comprising, first catalyst nanoparticles and a first polymer precursor comprising monomers having a third and a forth types of functional groups different from each other; adding crosslinking agent to the first catalyst solution, the cross-linking agent being configured to chemically bond to the functional groups of the third type; providing a second catalyst solution comprising, second catalyst nanoparticles and a second polymer precursor comprising monomers having a fifth and a sixth types of functional groups different from each other, adding the crosslinking agent comprising hydrocarbon chains to the second catalyst solution, the crosslinking agent being configured to chemically bond to the functional groups of the fifth type; depositing the first catalyst solution on a substrate to form a first catalyst layer; depositing the polymer precursor solution on top of the first catalyst layer to form the membrane; depositing the second catalyst solution on the deposited membrane to form a second catalyst layer, cross-linking the depositing membrane, the first and the second catalyst layers to form a catalyst coated membrane (CCM); and adding functionalization agent, the functionalization agent being configured to chemically react with the functional groups of the second, the forth and the sixth types to form ion conducting functional groups.

In some embodiments, the method may further include conducting of the crosslinking of the deposited membrane, the first and the second catalyst layers simultaneously. In some embodiments, crosslinking of the deposited membrane, the first and the second catalyst layers is conducted separately after each deposition step.

Some aspects of the invention may be directed to a catalyst layer for a membrane fuel cell. The catalyst layer may include catalyst nanoparticles; and cross-linked polymer ionomer comprising two types of functional groups, a first type of functional groups forming cross-linking bonds between two ionomer chains; and a second type of functional groups comprising ion conducting functional groups. In some embodiments, the crosslinking bonds does not include the ion conducting functional groups.

In some embodiments, the catalyst nanoparticles include one of a group consisting of: active metal nanoparticles, active metal nanoparticles supported on carbon nanoparticles and active metal nanoparticles supported on non-active metal nanoparticles.

Some additional aspects of the invention may be related to a method of forming a catalyst layer on a substrate. The method may include providing at least one catalyst solution comprising, at least one type of catalyst nanoparticles and a polymer precursor comprising monomers having a first type of functional groups and monomers having second type of functional groups, wherein the first and second types of functional groups are different from each other; adding a cross-linking agent to the at least one catalyst solution, the crosslinking agent being configured to chemically bond to the functional groups of the first type; applying the at least one catalyst solution on at least one side of a substrate, to form at least one catalyst layer; crosslinking the at least one catalyst layer; and adding ion conducting functionalization agent, the ion conducting functionalization agent being configured to chemically react with the functional groups of the second the type to form ion conducting functional groups.

In some embodiments, the first type of functional group contains one of: a dithioether type crosslink of the form P—R—S—R′—S—R—P, and an alkyl or aryl (or derivatives thereof) crosslink of the form P—R—P, where P represents the ionomer chains being crosslinked, R and R′ being alkyl or aryl chain or derivatives thereof, and S being a sulfur atom. In some embodiments, the second type of functional groups may an anion conducting type of functional groups, In some embodiments, the second type of functional group may be a quarternary ammonium type of functional group.

In some embodiments, the substrate is selected from a group consisting of: a membrane, a supported membrane, a gas diffusion layer (GDL) and a micro porous layer (MPL).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is an amination reaction of styrene based precursor polymer to form positively charged quaternary ammonium anion conducting group, as known in the art;

FIG. 1B is a crosslinking reaction of styrene based precursor polymer (of FIG. 1A) to form linkage between two polymer chains using Tetra-methyl-1,6-hexane di-amine (TMHDA) cross linker agent, as known in the art;

FIG. 2A is a flowchart of a method of making a membrane for fuel cells according to some embodiments of the invention;

FIG. 2B is a flowchart of a method of making a catalyst coated membranes (CCMs) according to some embodiments of the invention;

FIGS. 3A-3C are examples for polymerization, crosslinking and functionalization reactions according to some embodiments of the invention;

FIGS. 4A-4C are illustrations of membranes for fuel cells according to some embodiments of the invention;

FIGS. 5A-5C are illustrations of catalyst coated membranes (CCMs) according to some embodiments of the invention;

FIG. 6 is a flowchart of a method of making a catalyst layer according to some embodiments of the invention;

FIGS. 7A-7B are illustrations of catalyst layers according to some embodiments of the invention; and

FIG. 8 shows examples for ion conducting functional groups according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Aspects of the invention may be directed to forming more durable fuel cells by introducing a novel method of crosslinking ionomers. According to some embodiments of the invention, the crosslinking stage is conducted first using a first type of functional groups followed by the functionalization stage that introduce the ion conducting groups to form the ionomer. The outcome of such process is a conducting crosslinked polymer that includes a first type of functional groups forming crosslinking bonds between two ionomer chains and a second type of functional groups that includes ion conducting functional groups. In some embodiments, the crosslinking bonds do not include the ion conducting functional groups. A conducting polymer according to some embodiments of the invention may be included in the membrane, the cathode catalyst layer and/or the anode catalyst layer of either AEM or PEM fuel cells.

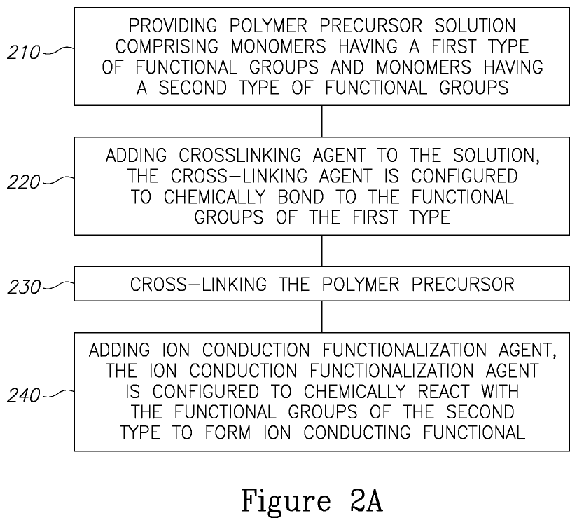

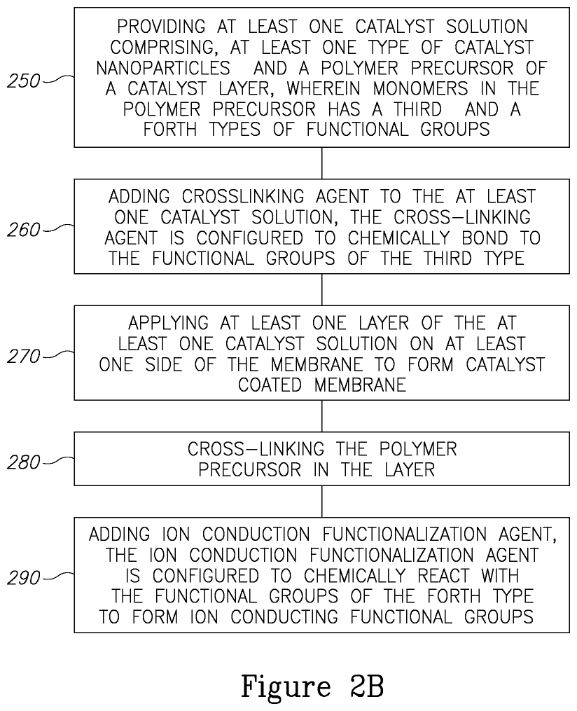

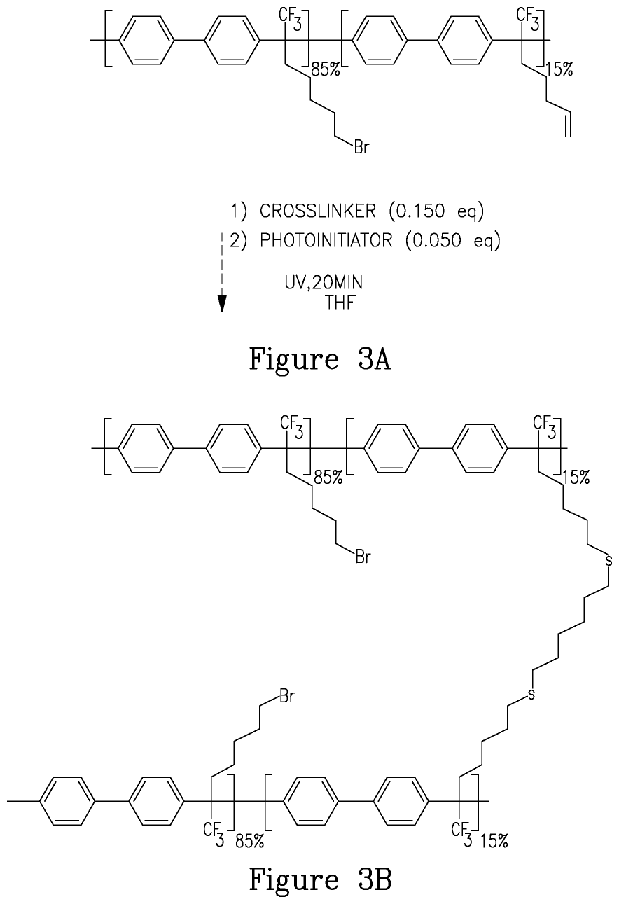

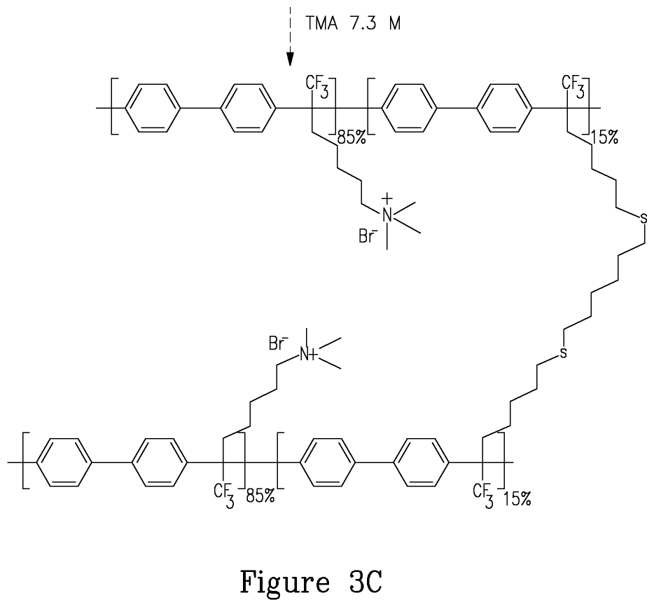

Reference is now made to FIG. 2A which is a flowchart of a method of making a membrane according to some embodiments of the invention. In step 210, polymer precursor solution comprising monomers having a first type of functional groups and monomers having a second type of functional groups may be provided. In some embodiments, the first and second types of functional groups are different from each other. In some embodiments, providing the polymer precursor solution may include providing monomer solution and/or conducting polymerization process to the monomers. For example, providing the polymer precursor solution may include providing Bi-Phenyl backboned with two functional groups: an alkene tether (as the first functional group) and alkyl halide (as the second functional group), as illustrated in FIG. 3A. As should be understood by a person skilled in the art the precursors and polymers in FIGS. 3A-3C are given as examples only and the invention as a whole is not limited to a specific polymeric chemistry.

In step 220, a crosslinking agent may be added to the solution, the cross-linking agent may be configured to chemically bond to the functional groups of the first type. For example, 1,6-hexanedithiol cross linker agent (a dithiol crosslinking agent) may be added to the biphenyl backboned precursor to cause two monomers functionalized with alkene tether functional group to form cross linking or bridge between two precursor polymer chains to form a dithioether, as shown in FIG. 3B. In some embodiments, other crosslinking agents may include for example, one of a group consisting of: hydrocarbon chains, sulfur groups, siloxy groups, N-hydroxybenzotriazole groups and Azide groups and the like.

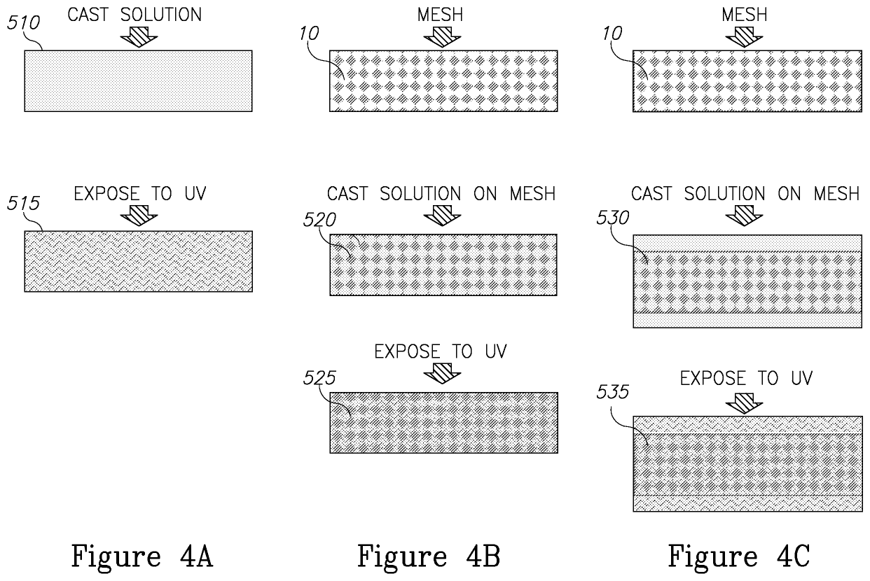

In some embodiments, the polymer precursor may be given a shape of a membrane, for example, by casting the polymer precursor solution and the crosslinking agent to form the membrane. In some embodiments, other fabrication methods may be conducted, for example, printing the polymer precursor solution on top of a substrate (e.g., a catalyst layer or any other substrate). In some embodiments, the polymer precursor solution may be inserted into a mesh to form a supported membrane. Some illustrations of membranes in various production stages according to embodiments of the invention are given and discussed with respect to FIGS. 4A-4C.

In step 230, the polymer precursor may be crosslinked, as presented in FIG. 3B. The polymer precursor, e.g., in the form of a membrane, may be exposed to ultraviolet (UV) radiation or to any other initiation source to activate the crosslinking process, possibly in the presence of a suitable initiator.

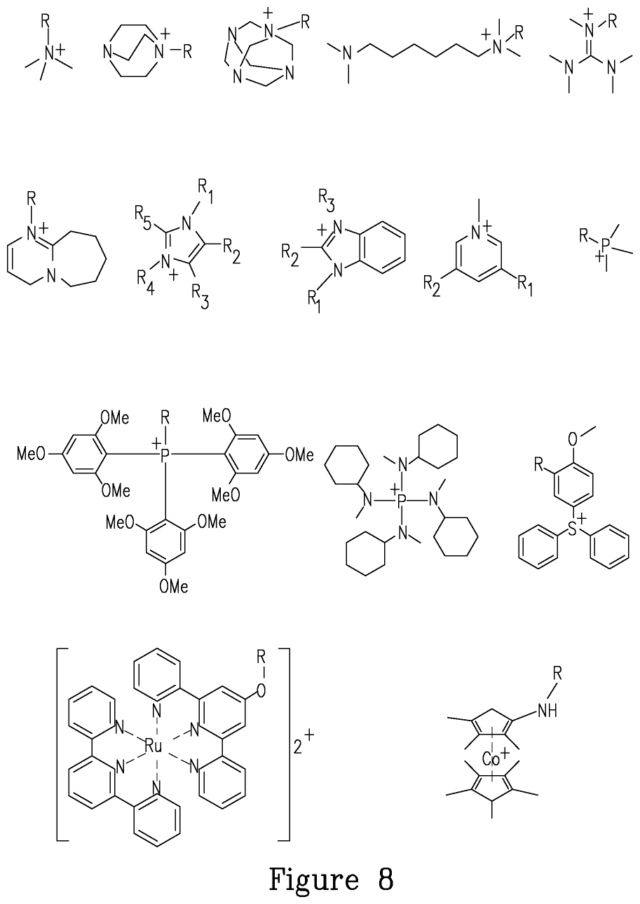

In step 240, ion conduction functionalization agent may be added to the membrane, the ion conduction functionalization agent may be configured to chemically react with the functional groups of the second type to form ion conducting functional groups, for example, the ion conducting groups illustrated in FIG. 8. For example, trimethylamine (TMA) may be added to react with the alkyl halide to form a quaternary ammonium type of conducting functional group as illustrated in FIG. 3C. The final microstructure of the membrane, of FIG. 3C, may include a first type of functional group containing dithioether crosslink groups of the form P—R—S—R′—S—R—P and a second type of functional group contacting quaternary ammonium conducting functional groups, as illustrated, or any anion conducting group. In another example, the final microstructure of a membrane according to some embodiments of the invention may include a first type of functional group containing alkyl or aryl crosslink of the form P—R—P, where P represents the ionomer chains being crosslinked, R and R′ being alkyl or aryl chain, and S being a sulfur atom and the second type may be any anion conducting group.

In some embodiments, the above chemical microstructure may be selected in order to ensure that the selected crosslinking group is stable to alkaline conditions. Therefore, the functional group that is to be crosslinked should not consist of quaternary ammonium, phosphonium or other cationic groups that, whilst they may act as ion exchange units and are thus beneficial to the performance of an alkaline exchange membrane, are susceptible to decomposition under alkaline conditions, especially if also accompanied by low hydration levels. Accordingly, a method of producing an anion conducting membrane according to some embodiments of the invention may include choosing a different chemical nature to the crosslinked group from the remaining functional groups that may be converted in a separate (earlier or later) step to anion conducting groups.

In some embodiments, the benefits of using the selected chemistries may include using the cross-linkable functional group that may be generated from a standard, unmodified precursor polymer with only the alkyl halide functional group via a halide elimination reaction to form the alkene.

In some embodiments, at least some of the solvent in the precursor solution may be evaporated to form a drier membrane prior or after adding the functionalization agent. The membrane may be dried according to any known method.

In some embodiments, additional catalyst layers may be applied on one or two sides of the membrane to form a catalyst coated membrane (CCM). In some embodiments, at least one catalyst solution may be provided. The at least one catalyst solution may include at least one type of catalyst nanoparticles and a polymer precursor of a catalyst layer, such that monomers in the polymer precursor have a third and a forth types of functional groups different from each other. In some embodiments, the third and a forth types of functional groups may be the same as or different from the first and second functional groups respectably.

In some embodiments, a crosslinking agent may be added to the at least one catalyst solution, the cross-linking agent may be configured to chemically bond to the functional groups of the third type. In some embodiments, the crosslinking agent may include for example, one of a group consisting of: hydrocarbon chains, sulfur groups, siloxy groups, N-hydroxybenzotriazole groups and Azide groups and the like. In some embodiments, the catalyst solution may include similar functional groups as the membrane, as disclosed herein above.

In some embodiments, the at least one catalyst solution may be applied on at least one side of the membrane to form a catalyst coated membrane (CCM). The catalyst solution may be printed, cast, sprayed and the like on one or both sides of the membrane. In some embodiments, a first catalyst solution that include the third functional group and the crosslinking agent may be applied on one side of the membrane and a second catalyst solution may be applied on a second side of the membrane. In some embodiments, the second catalyst solution may not include the crosslinking agent. In some embodiments, the CCM may be crosslinked using any known method (e.g., UV radiation, heat etc.). In one embodiment, when two catalyst layers that include crosslinking agent are applied, both sides of the membrane may be crosslinked. In another embodiment, if only the first catalyst layer includes crosslinking agent (e.g., the anode catalyst layer) and the second catalyst does not (e.g., the cathode catalyst layer) only the first catalyst layer may be crosslinked.

In some embodiments, crosslinking the polymer precursor in the membrane and the crosslinking the polymer precursor in the at least one catalyst layer may be conducted in separate steps. In such case, the at least one catalyst layer may applied to a crosslinked fully functionalized ion conducting membrane. In some embodiments, the cross-linking of the polymer precursor in the membrane and the crosslinking of the polymer precursor in the at least one layer may be conducted simultaneously. In such case the at least one catalyst layer may be applied to the membrane directly after forming the membrane (e.g., casting, printing and the like) and the crosslinking (e.g., application of UV radiation) may be conducted simultaneously on the entire CCM. In some embodiments, the first type of functional group in the membrane precursor may be the same as the third type functional group in the catalyst layer, such that upon conducting simultaneous crosslinking process, crosslinking chemical bond may be formed also in the interface between the membrane and the at least one catalyst layer. For example, the first and third type of functional groups may be include dithioether crosslink groups of the form P—R—S—R′—S—R—P. In another example, the first type and third type of functional groups containing alkyl or aryl crosslink of the form P—R—P, where P represents the ionomer chains being crosslinked, R and R′ being alkyl or aryl chain, and S being a sulfur atom.

In some embodiments, following the crosslinking process ion conducting functionalization agent may be added to the CCM. In some embodiments, the ion conducting functionalization agent may configured to chemically react with the functional groups of the forth types to form ion conducting functional groups (e.g., anion conducting function group), as discussed with respect to step 240. In some embodiments, the ion conducting functionalization agent may be added only to the at least one catalyst layer when the membrane is already ion-conducting. In some embodiments, the ion conducting functionalization agent may be added simultaneously to the membrane and the at least one catalyst layer after a simultaneous crosslinking process to form ion-conductivity in all parts of the CCM.

In some embodiments, forming a CCM may be conducted using any depositing process, such as spraying or printing (e.g., die Coating, doctor blade, silk printing and the like). An example for such a process may include repeating steps 210 and 220 of the method of FIG. 2. The process may further include providing a first catalyst solution comprising, first catalyst nanoparticles and a first polymer precursor that includes monomers having a third and a forth types of functional groups different from each other and adding a crosslinking agent to the first catalyst solution. The cross-linking agent may be configured to chemically bond to the functional groups of the third type. The process may further include providing a second catalyst solution that include second catalyst nanoparticles and a second polymer precursor comprising monomers having a fifth and a sixth types of functional groups different from each other and adding the crosslinking agent comprising hydrocarbon chains to the second catalyst solution, the crosslinking agent being configured to chemically bonded to the functional groups of the fifth type.

In some embodiments, the process may further include: deposing (e.g., printing, spraying and the like) the first catalyst solution on a substrate to form a first catalyst layer; depositing the polymer precursor solution on top of the first catalyst layer to form the membrane and depositing the second catalyst solution on the deposited membrane to form a second catalyst layer. Following the deposition process the deposited CCM may be crosslinked simultaneously, using any known method. Alternatively, the crosslinking process of the membrane and the first and the second catalyst layers may be conducted separately after each deposition step. After the completion of the crosslinking process a functionalization agent may be added to the CCM. In some embodiments, the functionalization agent may be configured to chemically react with the functional groups of the second, and forth and sixth types to form ion conducting functional groups.

In some embodiments, in order to form crosslinking in the interface between the deposited membrane and the deposited first and second catalyst layer, the first, third and fifth functional groups may be the same.

Reference is now made to FIGS. 4A-4B which are illustrations of membranes according to some embodiments of the invention during various fabrication stages. Membranes 510, 520 and 530 may be fabricated using any method for applying a polymer precursor known in the art, for example, casting, printing and the like. Membrane 510 may be formed by applying a polymer precursor solution on top of a substrate. The polymer precursor solution may include monomers having a first type of functional groups and monomers having a second type of functional groups wherein the first and second types of functional groups are different from each other. The polymer precursor solution may further include a crosslinking agent that is configured to be chemically bonded to the first type of functional groups. Membranes 520 and 530 may be formed by inserting the polymer precursor solution to a mesh 10 in two options, when the polymer precursor covers substantially the entire mesh, as illustrated in FIG. 4B, and when the polymer precursor expands beyond the mesh to form thin layers on surfaces of the mesh, as illustrated in FIG. 4C.

Membranes 510, 520 and 530 may be crosslinked, for example, using UV radiation, and further be exposed to ion conduction functionalization agent, the ion conduction functionalization agent may be configured to chemically react with the functional groups of the second type to form ion conducting functional groups.

The outcome of the process may include membranes such as membranes 515, 525 and 532. Each one of membranes 515, 525 and 532 may include crosslinked ionomer that includes two types of functional groups, a first type of functional groups forming crosslinking bonds between two ionomer chains and a second type of functional groups comprising ion conducting functional groups for example, the ion conducting functional groups of FIG. 8. In some embodiments, the crosslinking bonds may not include the ion conducting functional groups.

In some embodiments, the first type of functional groups forming the crosslinking bonds may include, for example, hydrocarbon chains, Sulfur group —S—S—S— formed using Vulcanization, siloxy group —Si—O—Si— formed using Salinization, N-hydroxybenzotriazole group —N═C═N— formed using Carbodiimide, Azide group —N═N═N- and the like.

In some embodiments, membranes 525 and 532 may further include mesh 10 for supporting the crosslinked ionomer. In some embodiments, the ionomer may be crosslinked also to the mesh when the mesh includes the required functional groups. The required functional groups may be similar to the first type of functional groups.

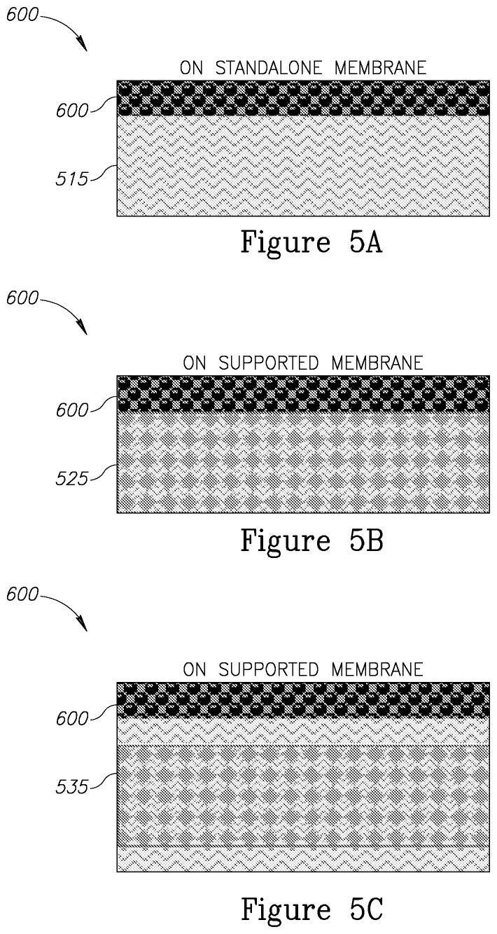

Reference is now made to FIGS. 5A-5C which are illustrations of CCMs according to some embodiments of the invention. CCMs 610, 620 and 630 may include membranes 515, 525 and 532 coated with at least one catalyst layer 600 attached to at least one side of membranes 515, 525 and 532. Catalyst layer 600 may include catalyst nanoparticles and crosslinked ionomer of the catalyst layer that include two types of functional groups, a third type of functional groups forming cross-linking bonds between two ionomer chains of the catalyst layer and a forth type of functional groups comprising ion conducting functional groups. In some embodiments, the crosslinking bonds may not include the ion conducting functional groups. In some embodiments, the first and third types of functional groups are the same. In some embodiments, in such case the same crosslinking bonds are formed across the interface between membranes 515, 525 or 535 and at least one catalyst layer 600.

In some embodiments, the fourth ion-conducting groups and the second ion-conducting groups may be the same or may be different, for example, the ion-conducting groups shown in FIG. 8.

In some embodiments, a first catalyst layer 600 may be attached to a first side of the catalyst coated membrane 610, 620 and 630 may include first catalyst nanoparticles and the crosslinked ionomer of the catalyst layer. In some embodiments, a second catalyst layer (not illustrated) may be attached to a second side of the catalyst coated membrane that may include non-crosslinked ionomer and a second catalyst nanoparticles.

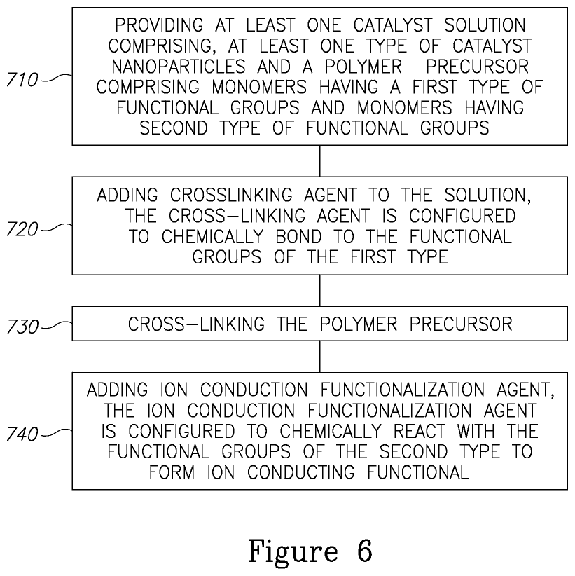

Reference is now made to FIG. 6 which is a flowchart of a method of forming a catalyst layer on a substrate according to some embodiments of the invention. In step 710, at least one catalyst solution may be provided. The catalyst solution may include, at least one type of catalyst nanoparticles and a polymer precursor comprising monomers having a first type of functional groups and monomers having second type of functional groups, wherein the first and second types of functional groups are different from each other. In some embodiments, the catalyst nanoparticles may include at least one of a group consisting of: active metal nanoparticles, active metal nanoparticles supported on carbon nanoparticles and active metal nanoparticles supported on non-active metal nanoparticles.

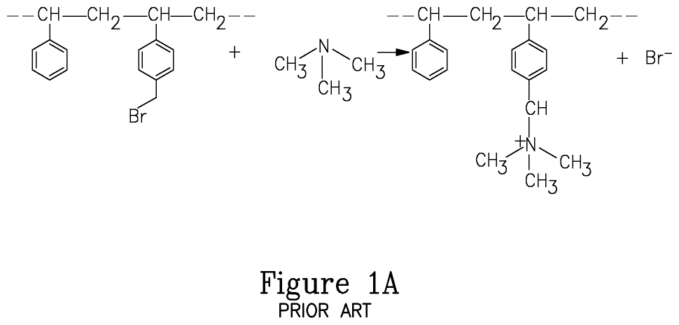

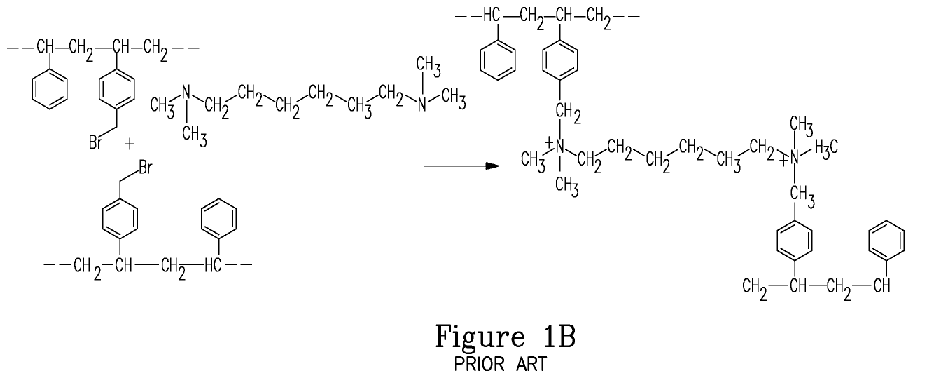

In some embodiments, providing the polymer precursor may include providing monomer solution and/or conducting polymerization process to the monomers. For example, a polymerization reaction may be carried out to yield a non-ion-conducting precursor material with an alkyl halide (for example, Br, Cl or I) functional group to form the precursor polymer, as illustrated in FIG. 1A. The polymerization reaction may further introduce adding styrene based precursor polymer to form the polymer chains using di-vinyl chemistry. In such case the first and second types of functional groups are the double bond and the alkyl halide, as presented in FIGS. 3A and 3B respectively.

In yet another example, presented in FIG. 4A, providing the polymer precursor may include providing Bi-Phenyl backboned with two functional groups alkene tether (the first functional group) and alkyl halide (the second functional group). As should be understood by a person skilled in the art the precursors and polymers in FIGS. 1, 3 and 4 are given as examples only and the invention as a whole is not limited to specific polymeric chemistry.

In step 720, cross-linking agent may be added to the at least one catalyst solution, the crosslinking agent being configured to chemically bond to the functional groups of the first type, as discussed above with respect to step 220.

In step 730, the at least one catalyst solution may be applied on at least one side of a substrate, to form at least one catalyst layer. In some embodiments, applying the catalyst layer may include, depositing, printing, casting, etc., the catalyst solution on top of the substrate. In some embodiments, the substrate may be selected from a group consisting of: a membrane, a supported membrane, a gas diffusion layer (GDL) and micro porous layer (MPL).

In step 740, the at least one catalyst layer may be crosslinked as discussed above with respect to step 240. In step 750 an ion conducting functionalization agent can be added to the catalyst layer. The ion conducting functionalization agent may be configured to chemically react with the functional groups of the second type to form ion conducting functional groups, as discussed above with respect to step 250.

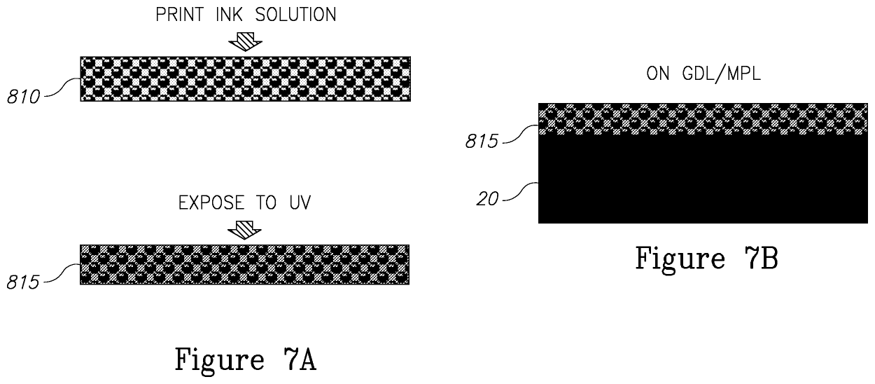

Reference is now made to FIGS. 7A and 7B with are illustration of catalyst layers for a membrane fuel cell according to some embodiments of the invention. Layer 810 may be applied on top of a substrate 20 as disclosed above in step 710-730. Layer 810 may be crosslinked and functionalized to form layer 815, as discussed in steps 740-750. Layer 815 may include catalyst nanoparticles and cross-linked polymer ionomer that include two types of functional groups. The two types of functional groups may include a first type of functional groups forming cross-linking bonds between two ionomer chains and a second type of functional groups that include ion conducting functional groups for example, the ion conducting functional groups of FIG. 8. In some embodiments, the crosslinking bonds may not include the ion conducting functional groups.

In some embodiments, the first type of functional groups forming the crosslinking bonds may include, for example, hydrocarbon chains, Sulfur group —S—S—S— formed using Vulcanization, siloxy group —Si—O—Si— formed using Silanization, N-hydroxybenzotriazole group —N═C═N— formed using Carbodiimide, Azide group —N═N═N- and the like.

### EXAMPLES

### Example 1—Making a Standalone Membrane (e.g., Membrane 515)

1. To a container equipped with stirrer was added (e.g. 300 mg) precursor polymer of 60 kDa in molecular size/weight (Range: 10 kda to 100 kDa) of Bi-Phenyl backboned (illustrated in FIG. 4A) made of 85% monomers functionalized with alkyl halide (Br or Cl) and 15% monomers functionalized with alkene tether—see FIG. 5A (Range: 95%:5% to 75%:25%).
2. 9.0 ml of tetrahydrofuran (THF) solvent, or other solvents, was added at a solvent volume to precursor polymer weight ratio of 3 ml/100 mg (Range: 2 ml/100 mg to 6 ml/100 mg).
3. The solution was stirred for 3 hr (Range: 2 hr to 6 hr) until the precursor polymer was fully dissolved and a uniform dark yellow viscous solution was formed.
4. 0.0184 ml of 1,6-Hexanedithiol cross linker (XL) agent was added at a eq. mole cross linker agent to precursor average monomer ratio (since in the precursor 85% of monomers are functionalized with alkyl halide and 15% are functionalized with alkene tether) of 0.15 mole/1 mole (Range: 0.05 mole/1 mole to 0.25 mole/1 mole).
5. 7.33 mg of Benzophenone photo-initiator was added at a eq. mole photo-initiator to cross linker agent ratio of 1 mole/3 mole (Range: 1 mole/1 mole to 1 mole/5 mole).
6. The solution was stirred for 10 min (Range: 5 min to 30 min) for forming a fully uniform solution.
7. The formed solution was casted onto a flat glass surface (9 cm×9 cm square) at a volume solution to area of 1 ml/9 cm² (Range: 1 ml/2 cm² to 1 ml/20 cm²) and cover glass to avoid solvent evaporation.
8. The cast solution was exposed to 365 nm UV radiation (Range: 200 nm to 400 nm) for 20 min (Range: 1 min to 40 min) to create cross linking of precursor polymer inside the casted solution.
9. The solvent was evaporated during 48 hr (Range: 12 hr to 96 hr) at 20° C. temperature (Range: 20° C. to 100° C.) to form a dry precursor membrane (i.e. a membrane that is not functionalized with ion conducting functional groups) made of UW cross linked precursor polymer—see FIG. 4B.
10. The result was approximately ˜30 μm (Range: 10 μm to 50 μm) precursor membrane ready for functionalization with ion conducting function groups, illustrated in FIG. 3C.

### Example 2—Making a Mesh Supported Standalone Membrane (e.g., Membranes 525 and 535)

Steps 1-6 were conducted substantially the same as in Example, 1.
7. The formed solution was die coated a flat ˜30 μm (Range: 10 μm to 50 μm) mesh support surface in the form of 9 cm×9 cm square at a volume solution to area of 1 ml/9 cm2 (Range: 1 ml/2 cm2 to 1 ml/20 cm2) and cover surface to avoid solvent evaporation.
8. The cast mesh support was exposed to 365 nm UW radiation (Range: 200 nm to 400 nm) for 20 min (Range: 1 min to 40 min) to create crosslinking of precursor polymer inside the casted solution.
Steps 9 and 10 were conducted substantially the same as in Example, 1.

### Example 3, Forming a Catalyst Layer

Steps 1-6 were conducted substantially the same as in Example, 1.

7. A catalyst material and/or support material and/or supplementary material (i.e. solid materials) at solid materials was added to precursor polymer weight ratio of 85 wt %/15 wt % (Range: 95 wt %/5 wt % to 50 wt %/50 wt %).
8. The solution was stirred until receiving a uniform catalyst ink.
9. The catalyst was deposited on top a flat membrane and/or gas diffusion layer (GDL) surface (9 cm×9 cm square) at a volume solution to area of 1 ml/9 cm² (Range: 1 ml/2 cm² to 1 ml/20 cm²) and cover surface to avoid solvent evaporation.
10. The catalyst layer was exposed to 365 nm UW radiation (Range: 200 nm to 400 nm) for 20 min (Range: 1 min to 40 min) to create cross linking of precursor polymer inside the catalytic layer.
11. The solvent was evaporated for 48 hr (Range: 121 hr to 96 hr) at 20° C. temperature (Range: 20° C. to 100° C.) to form dry catalyst layer.
12. The result was approximately ˜30 μm (Range: 10 μm to 50 μm) precursor catalyst layer ready for functionalization with ion conducting function groups, illustrated in FIG. 3C.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An anion conducting membrane: comprising:
crosslinked ionomer comprising at least two types of functional groups:
a first type of functional groups forming crosslinking bonds between two ionomer chains; and
a second type of functional groups comprising anion conducting functional groups,
wherein the crosslinking bonds does not include the ion conducting functional groups.

2. The membrane of claim 1, further comprising a mesh for supporting the crosslinked ionomer.

3. The membrane according to claim 1, wherein the first type of functional group contains one of: a dithioether type crosslink of the form P—R—S—R′—S—R—P, and an alkyl or aryl crosslink of the form P—R—P, where P represents the ionomer chains being crosslinked, R and R′ being alkyl or aryl chain, and S being a sulfur atom.

4. The membrane according to claim 3, wherein the second type of functional groups is an anion conducting type of functional groups.

5. The membrane according to claim 4, wherein the second type of functional group is a quarternary ammonium type of functional group.

6. The membrane according to claim 1, further comprising:
at least one catalyst layer attached to at least one side of the membrane to form a catalyst coated membrane (CCM),
wherein the at least one catalyst layer comprises at least:
catalyst nanoparticles and crosslinked ionomer of the catalyst layer comprising two types of functional groups:
a third type of functional groups forming cross-linking bonds between two ionomer chains of the catalyst layer; and
a forth type of functional groups comprising ion conducting functional groups,
wherein the crosslinking bonds does not include the ion conducting functional groups.

7. The membrane of claim 6, wherein a first catalyst layer attached to a first side of the CCM comprises first catalyst nanoparticles and the crosslinked ionomer of the catalyst layer and a second catalyst layer attached to a second side of the catalyst coated membrane comprises non-crosslinked ionomer of the catalyst layer and second catalyst nanoparticles.

8. The membrane according to claim 6, wherein the first and third types of functional groups are the same.

9. The membrane of claim 8, further comprising the same cross-linked chemical bonds across the interface between the membrane and the at least one catalyst layer.

10-11. (canceled)

12. A method of making a membrane, comprising:
providing polymer precursor solution comprising at least monomers having a first type of functional groups and monomers having a second type of functional groups wherein the first and second types of functional groups are different from each other;
adding crosslinking agent to the solution, the cross-linking agent being configured to chemically bond to the functional groups of the first type;
cross-linking the polymer precursor; and
adding an ion conduction functionalization agent, the ion conduction functionalization agent being configured to chemically react with the functional groups of the second type to form ion conducting functional groups.

13. The method of claim 12, wherein the cross-linking agent comprises one of a group consisting of: dithiol and dihalide.

14. The method of claim 12, further comprising:
casting the polymer precursor solution and the crosslinking agent to form a membrane.

15-16. (canceled)

17. A method according to claim 12, wherein the second type of functional groups is anion conducting functional groups.

18. The method of claim 17, wherein the second type of functional groups is a quarternary ammonium type of functional groups.

19. The method according to claim 12, further comprising:
providing at least one catalyst dispersion comprising, at least one type of catalyst nanoparticles and a polymer precursor of a catalyst layer, wherein monomers in the polymer precursor have a third and a forth types of functional groups different from each other;
adding crosslinking agent to the at least one catalyst dispersion, the cross-linking agent is configured to chemically bound to the functional groups of the third type;
applying at least one layer of the at least one catalyst solution on at least one side of the membrane to form catalyst coated membrane;
cross-linking the polymer precursor in the at least one layer, and
adding ion conducting functionalization agent, the ion conducting functionalization agent is configured to chemically react with the functional groups of the forth types to form ion conducting functional groups.

20. The method of claim 18, wherein applying the at least one catalyst solution is on a first side of the as cast membrane, the method further compromises:
applying another catalyst dispersion on a second side of the as-cast membrane, the second catalyst dispersion does not include a crosslinking agent.

21. The method of claim 19, wherein crosslinking the polymer precursor in the membrane and the crosslinking the polymer precursor in the at least one layer are conducted in separate steps.

22. The method of claim 19, wherein the first type of functional group is the same as the third type functional group.

23. (canceled)

24. A method according to claim 19, wherein the second type of functional groups is the same as the forth type of functional groups.

25. The method according to claim 12, further comprising:
providing a first catalyst solution comprising, first catalyst nanoparticles and a first polymer precursor comprising monomers having a third and a forth types of functional groups different from each other;
adding crosslinking agent to the first catalyst solution, the cross-linking agent being configured to chemically bond to the functional groups of the third type;
providing a second catalyst solution comprising, second catalyst nanoparticles and a second polymer precursor comprising monomers having a fifth and a sixth types of functional groups different from each other;
adding the crosslinking agent comprising hydrocarbon chains to the second catalyst solution, the crosslinking agent is configured to chemically bond to the functional groups of the fifth type;
depositing the first catalyst solution on a substrate to form a first catalyst layer;
depositing the polymer precursor solution on top of the first catalyst layer to form the membrane;
depositing the second catalyst solution on the deposited membrane to form a second catalyst layer;
cross-linking the depositing membrane, the first and the second catalyst layers to form a catalyst coated membrane (CCM); and
adding functionalization agent, the functionalization agent is configured to chemically react with the functional groups of the second, the forth and the sixth types to form ion conducting functional groups.

26-35. (canceled)
